(19) United States
(12) Patent Application Publication
(10) Pub. No.: US 2015/0294789 A1
(43) Pub. Date: Oct. 15, 2015

(54) METHOD FOR PRODUCING COIL ELEMENT USING RESIN SUBSTRATE AND USING ELECTROFORMING

(71) Applicant: LEAP CO., LTD., Kanagawa (JP)

(72) Inventors: Takashi Sano, Kanagawa (JP); Tokinori Terada, Kanagawa (JP)

(73) Assignee: LEAP CO., LTD., Kanagawa (JP)

(21) Appl. No.: 14/438,960

(22) PCT Filed: Oct. 30, 2012
(86) PCT No.: PCT/JP2012/006962

§ 371 Date: Apr. 28, 2015

(51) Int. Cl. H01F 41/04; C25D 1/00

(52) U.S. Cl. CPC H01F 41/04; C25D 1/00

(57) ABSTRACT

A method for manufacturing a coil element including forming a groove in a substrate surface of a resin substrate, forming a metallic coating, forming a resist pattern being a reverse pattern of a coil element pattern on the surface to sandwich the groove, so as to have a thickness, forming a central conductive film of the coil element on the surface including the groove, by electroforming with the resist pattern as a mask, so as to have a height equal to or less than the thickness, removing the resist pattern and the exposed metallic coating forming a surface conductive film by electroforming with the central conductive film as a foundation, to form a coil element made of the central conductive film and surface conductive film, peeling away the coil element from the substrate, and removing a portion formed in the groove, of the central conductive film by reverse electrolytic etching.

### CROSS REFERENCE TO RELATED APPLICATION

This application is the National Stage of International Application No. PCT/JP2012/006962 having an International Filing Date of 30 Oct. 2012, which designated the United States of America, and which International Application was published under PCT Article 21 (s) as WO Publication 2014/068614 A1, the disclosures of which are incorporated herein by reference in their entireties.

### BACKGROUND

The presently disclosed embodiment relates to a method for manufacturing a coil element using a resin substrate by electroforming (also referred to as electroplating).

Along with recent multi-functionalization of mobile devices such as smart phones and tablets, the need for compact coil component (inductor) capable of dealing with high current rating is increasing.

In addition, the coil component with a conductive pattern of so-called high aspect, whose coil pattern width is narrow and which has a large thickness, is very much needed.

As a method for manufacturing such a coil component, Japanese Patent Application Laid-Open No. H05-075237 describes a method for forming a thin film conductor of a predetermined pattern.

This method is to provide a patterned plating mask layer on a plating underlying conductive film coating an insulator, provide a plating film by a first plating step so as to fill unmasked portion of the plating mask layer, then remove the plating mask layer and exposed underlying conductive film, and coating a surface of the plating film by a second plating step for thickening to narrow a conductive pattern interval.

In addition, Japanese Patent Application Laid-Open No. H08-138941 describes forming a wound coil-like plated conductor by electroforming after forming a plating resist pattern on a substrate, transferring it onto a sheet-like magnetic layer after removing the plating resist pattern, and connecting a plurality of wound coil-like plated conductors via a through hole provided in the sheet-like magnetic layer.

### SUMMARY

The method described in Japanese Patent Application Laid Open No. H05-075237 relates to a method for forming a coil component integrated with an insulator without being peeled away from the insulator, and is not a method for manufacturing a coil component by peeling away from the insulator and transfer.

Therefore, it does not consider at all measures for preventing overturning or dropping of the conductive pattern with the peeling and transfer.

The method described in Japanese Patent Application Laid-Open No. H08-138941 is to form a coil-like plated conductor by peeling a conductive pattern from a substrate and transfer. It merely describes improving adhesiveness of a plating resist pattern by roughening a substrate surface moderately and secondarily improving an effect of preventing a conductive pattern from releasing from mold in a peeling step of the plating resist pattern, and does not describe positively preventing overturning or dropping of the conductive pattern with the peeling and transfer.

Thus, the conventional methods of manufacturing a coil component have not solved the problem of preventing overturning or dropping of the conductive pattern with the peeling and transfer thereof.

The presently disclosed embodiment is made to solve the above problem and aims at manufacturing a coil component with a conductive pattern of high aspect while preventing overturning or dropping of the conductive pattern with the peeling and transfer thereof.

The above problem can be solved by the following presently disclosed embodiment.

Means of the presently disclosed embodiment is a method for manufacturing a coil element by electroforming using a resin substrate, comprising: forming a groove on a substrate surface of the resin substrate in order to prevent overturning or dropping of the coil element; forming a metallic coating serving as a seed layer to coat the resin substrate on which the groove is formed; forming a resist pattern for forming a desired aspect ratio of the coil element, on the substrate surface to sandwich the groove, so as to have a desired thickness T, the resist pattern being a reverse pattern of the coil element pattern; forming a central conductive film of the coil element on the substrate surface including the groove, by a first electroforming with the resist pattern as a mask, so as to have a height t equal to or less than the desired thickness T; removing the resist pattern and the metallic coating exposed; forming a surface conductive film by a second electroforming with the central conductive film as a foundation, to form the coil element made of the central conductive film and surface conductive film; peeling away the coil element from the resin substrate; and removing a portion formed in the groove, of the central conductive film of the peeled coil element by a reverse electrolytic etching.

Means of the presently disclosed embodiment further comprises implanting the coil element peeled away from the resin substrate to a component substrate.

According to the presently disclosed embodiment, a groove is formed on a substrate surface of the resin substrate and a central conductive film of a coil element is formed on the substrate surface including the groove in order to prevent overturning or dropping of the coil element. Thus, conductive patterns do not collapse and coil elements of high aspect can be manufactured.

### BRIEF DESCRIPTION OF THE DRAWINGS

FIGS. 1A-1G are views showing steps of manufacturing a coil element according to the presently disclosed embodiment.

FIG. 2 is a plan view showing a coil element assembly manufactured using a consumable mold substrate according to the presently disclosed embodiment.

FIG. 3 is a view showing a state in which a plurality of coil element assemblies is stacked.

FIGS. 4A-4C are explanatory views of stacking a plurality of coil element assemblies and connecting coil elements in respective layers to each other to form a coil.

FIG. 5 is a view showing a state in which a coil is sealed by upper and lower cores.

FIG. 6 is a view showing a state in which a coil is filled with insulating material.

FIGS. 7A-7B are views showing dicing for cutting stacked coil element assemblies into coils.

FIGS. 8A-8D are views showing steps of forming a coil component by attaching an external electrode to an electrode extraction part.

### DETAILED DESCRIPTION

The presently disclosed embodiment will be described in detail below according to the accompanying drawings.

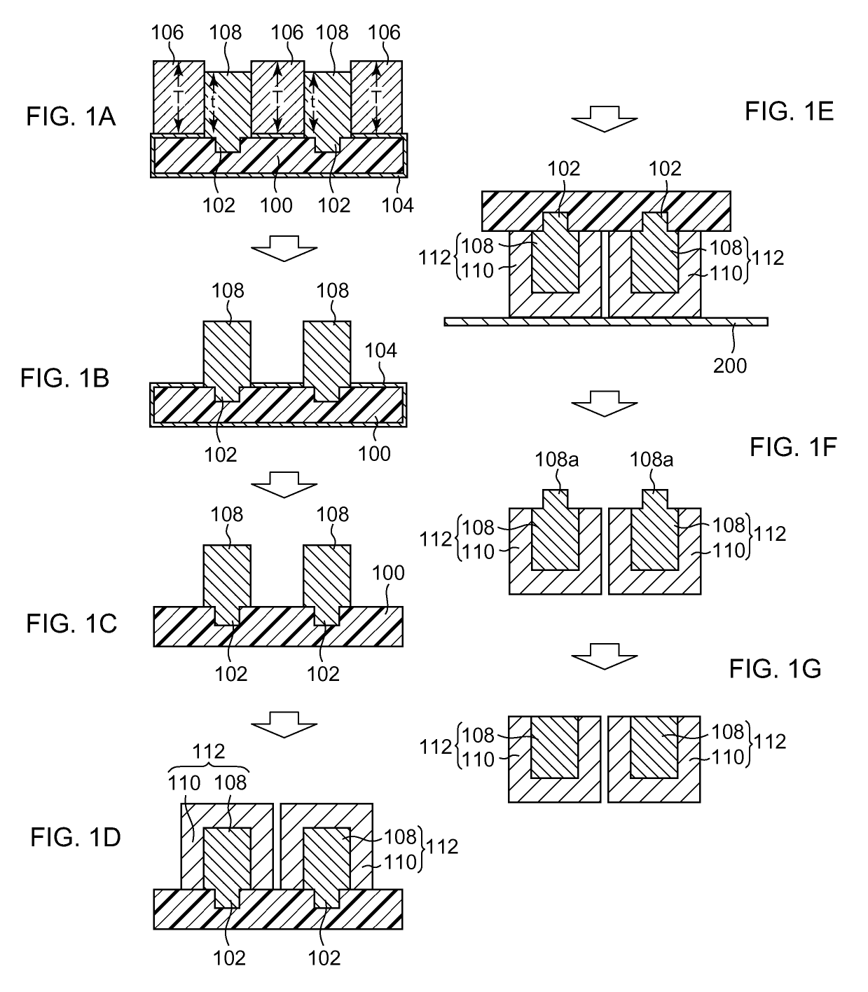

FIGS. 1A-1G are views showing steps of manufacturing a coil element according to the presently disclosed embodiment.

The presently disclosed embodiment uses a resin substrate and manufactures a coil element on the substrate.

The coil element formed on the resin substrate is peeled away from the resin substrate by transfer and the resin substrate after peeling away of the coil element is never reused. Thus, such a resin substrate can be called a consumable mold.

First, as shown in FIG. 1A, a resin substrate 100 is prepared and a groove 102 is formed on a surface of the substrate in order to prevent overturning or dropping of a coil element that will be formed on the resin substrate 100 in a subsequent step. There is no particular restriction in a shape of the groove 102 and a plurality of arbitrarily-shaped grooves may be formed.

However, it is necessary to form a sufficiently deep groove because roughening the substrate surface has only a small effect of preventing overturn or drop.

Next, in preparation for an electroforming (electroplating) process in a subsequent step, a metallic coating 104 serving as a seed layer is formed to coat the resin substrate on which the groove 102 is formed. The metallic coating 104 can be formed by non-electrolytic plating such as Cu and Ni or may be formed by vapor deposition.

Next, a resist pattern 106 to form a desired aspect ratio of the coil element, which is a reverse pattern of the coil element pattern, is formed on the substrate surface to sandwich the groove 102 so as to have a desired thickness T. At this time, side walls of the resist pattern 106 are made perpendicular to the substrate surface, thereby improving pattern density.

Next, by electrodepositing, for example, copper (Cu) using an electroforming with the resist pattern 106 as a mask, a central conductive film 108 of the coil element is formed on the substrate surface including the groove 102, so as to have a height t equal to or less than the thickness T. Controlling the height t in this manner is to prevent generation of protrusions of a top portion of the central conductive film 108 if the central conductive film 108 is electrodeposited above the thickness T of the resist pattern 106.

Then, as shown in FIG. 1B, the resist pattern 106 is removed, and the exposed metallic coating 104 is also removed as shown in FIG. 1C.

Then, as shown in FIG. 1D, for example, copper (Cu) is electrodeposited on a surface of the central conductive film 108 as a surface conductive film 110 by electroforming with the central conductive film 108 as a foundation.

This process is also called thickening plating and can narrow a pattern interval between the coil elements 112 made of the central conductive film 108 and surface conductive film 110. Then, the coil element 112 is implanted to a component substrate 200 by transfer as shown in FIG. 1E, or taken out only by being peeled away from the resin substrate as shown in FIG. 1F. Note that when implanted by transfer, it may be implanted to the component substrate 200 via an adhesive or to a green sheet (not shown) without an adhesive.

The coil element 112 taken out has a portion 108a of the central conductive film 108 formed in the groove 102, which protrudes in a shape of the groove.

Thus, a reverse electrolytic etching is conducted to remove the portion 108a.

The reverse electrolytic etching is a process for removing the plated metal by reverse etching with an electric field direction reversed. Note that since an electric field is concentrated in the portion 108a as compared to other portions, an etching rate increases and selective etching is conducted.

As a result, as shown in FIG. 1G, the coil element 112 without protrusion and of uniform shape, is formed.

In this way, it is possible to manufacture a coil component with a narrow pattern interval and arbitrary aspect ratio.

Although in the above description, the case where a single coil element is manufactured, is described, a coil element assembly having a plurality of coil elements is similarly manufactured using a resin substrate on which a plurality of reverse coil element patterns is formed.

Next, a method for manufacturing a coil component using the coil element assembly thus manufactured will be described. As stated later, a coil component is manufactured by stacking a plurality of coil element assemblies.

Thus, in order to connect coil elements in respective layers to each other by bonding, it is necessary to form a bonding film at a periphery of coil element in advance.

FIG. 2 is a plan view showing a coil element assembly 1000 manufactured according to the presently disclosed embodiment. A mold substrate for manufacturing this coil element assembly 1000 has the same shape as this. In order to reinforce conductive patterns of a plurality of coil elements 500 m, n (m, n=1, 2 . . . ), rib 502, gates 504, and runners 506 are provided. In addition, holes 508 are provided at the four corners of the rib 502, and the conductive patterns of the coil elements 500 m, n formed in respective layers of a plurality of coil element assemblies 1000 are aligned using pins 510 penetrating through the holes 508.

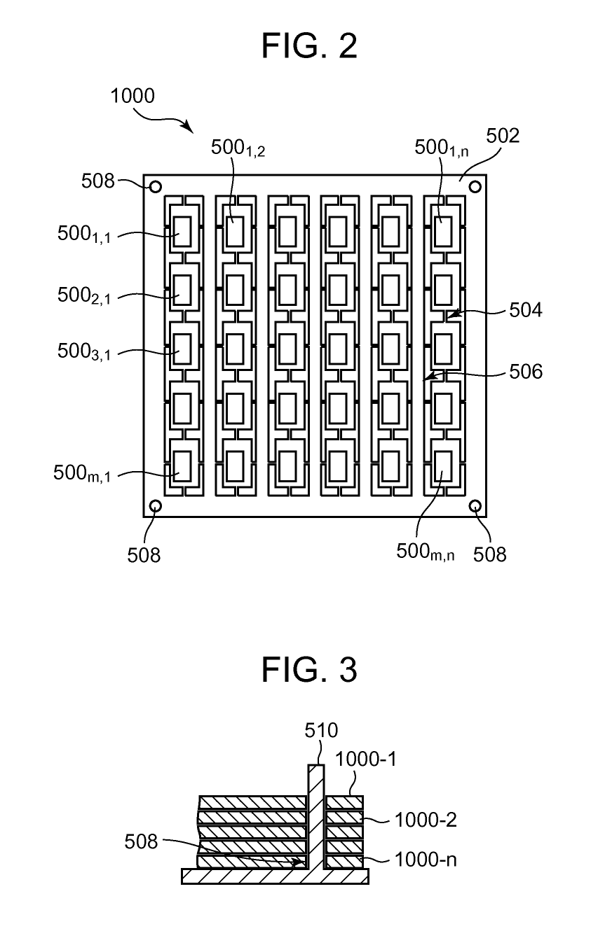

As shown in FIG. 3, a coil is formed by stacking a plurality of coil element assemblies 1000-1, 1000-2, . . . 1000-N via the pins 510 so that corresponding coil elements in respective coil element assemblies get into alignment with each other, bonding them to each other by heating and/or pressurizing, and connecting the coil elements in respective layers to each other. Tin plating serving as a coupling film melts by heating and/or pressurizing and functions as soldering to bond the coil elements in respective layers to each other.

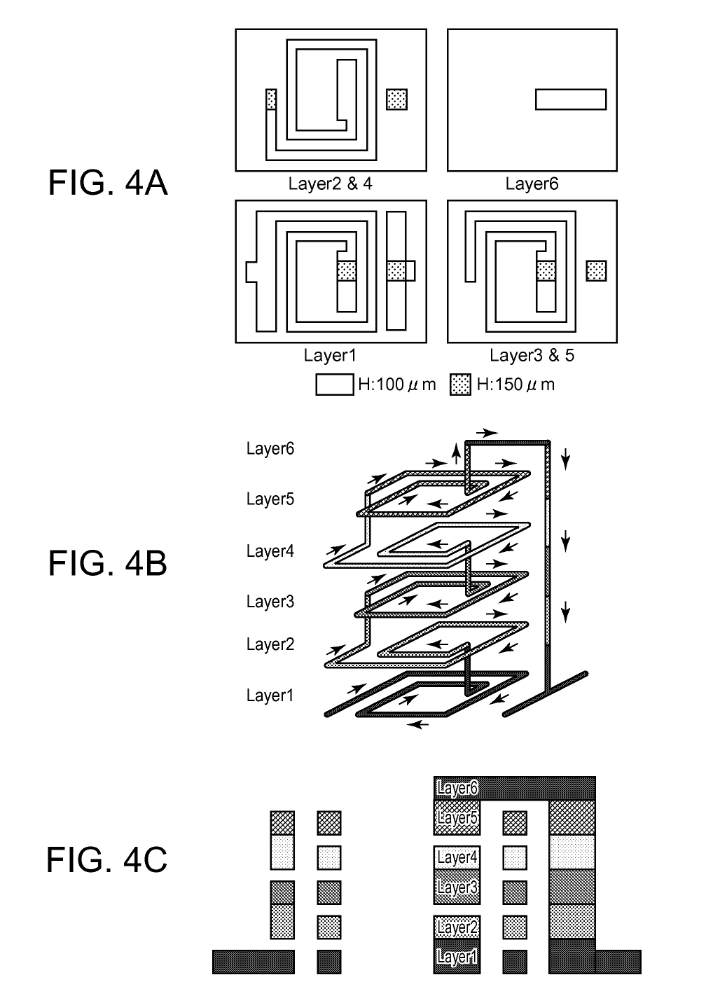

FIGS. 4A-4C are explanatory views of stacking a plurality of coil element assemblies and connecting coil elements in respective layers to each other to form a coil. The aspects as shown in FIGS. 4A-4C show the cases of stacking six coil element assemblies and connecting coil elements in respective layers to each other to form a single coil. Corresponding coil elements in the plurality of coil element assemblies can be configured to have different coil patterns from each other.

In the example shown in FIG. 4A, the first layer (Layer 1), third layer (Layer 3), and sixth layer (Layer 6) have different coil patterns from each other, the second layer (Layer 2) and fourth layer (Layer 4) have the same coil pattern, and the third layer (Layer 3) and fifth layer (Layer 5) have the same coil pattern. FIGS. 4B and 4C show stacking six coil element assemblies, bonding them so that corresponding coil elements in respective layers get into alignment with each other, and connecting the coil elements to each other to form a single coil.

Although in the above description of manufacture of the coil element, it is described as if the central conductive layer of the coil element has an equal height (H), the layer height at the connection part of each layer is different as shown in FIG. 4A. In the example shown in FIG. 4A, the normal pattern of the coil element has the height (H) of 100 μm, while the height (H) at the connection portion between layers is 150 μm.

Such manufacture of coil pattern of different heights (H) in the same layer can be achieved by increasing a depth of an etching pattern formed on a transfer mold at a connection portion and selectively performing filling plating on the deep portion using a special copper plating solution for filled via or performing copper plating using a mask twice.

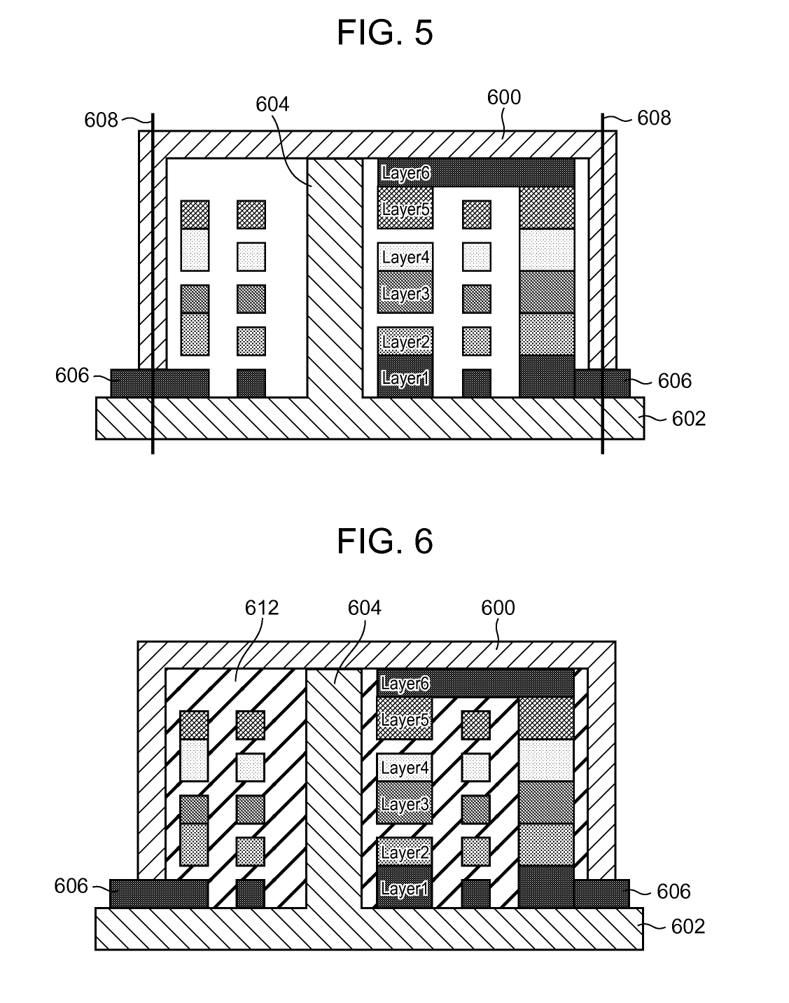

After forming a coil by connecting the coil elements in respective layers as described above, the coil is sealed with electrode extraction parts 606 exposed outside, by using magnetic upper core 600 and lower core 602 either of which has a projection 604 penetrating through the center of the coil as shown in FIG. 5. At this time, the upper core 600 and lower core 602 are mounted so as to avoid the gate 504 for pattern reinforcement shown in FIG. 2. Note that the upper core 600 and lower core 602 are cut along dicing lines 608 in the subsequent dicing step. Then, as shown in FIG. 6, an insulating material 612 is filled through a gap (not shown) between the upper core 600 and lower core 602 to fix the coil.

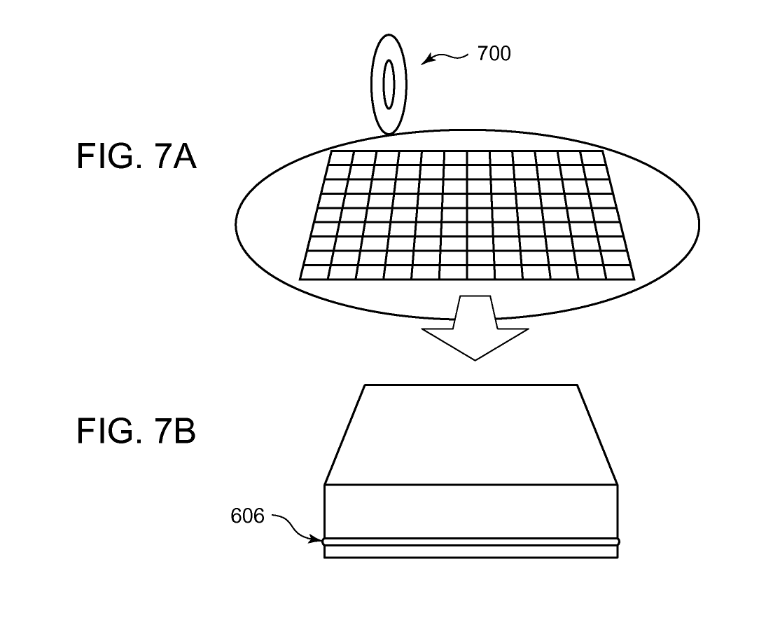

Then, stacked coil element assemblies are cut into coils using a cutter 700 as shown in FIGS. 7A-7B. FIG. 7A shows a coil element assembly, and FIG. 7B shows a single coil component, an electrode extraction part 606 of which is formed as a part of the first layer (Layer 1).

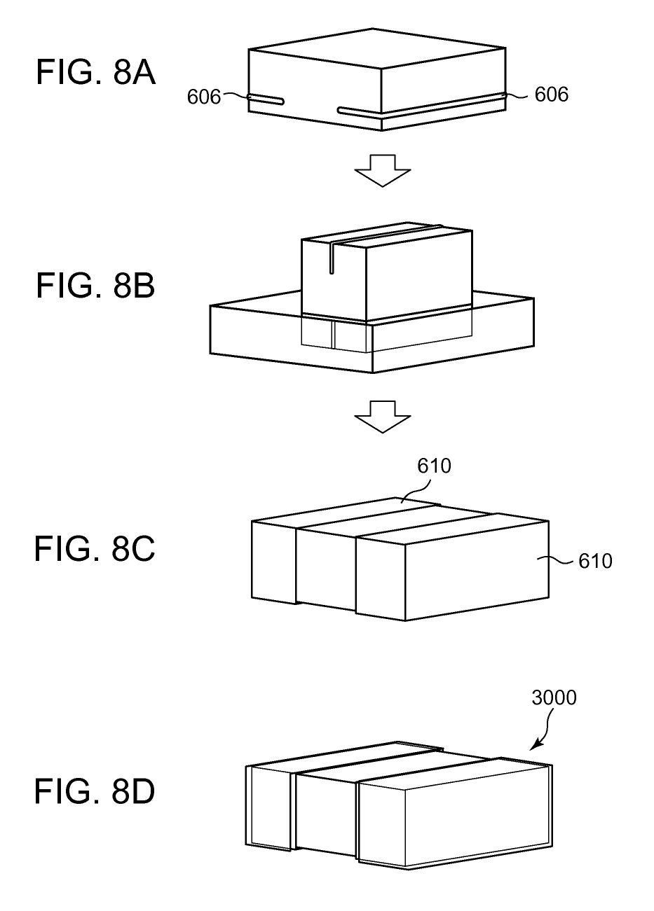

Finally, as shown in FIGS. 8A-8D, an external electrode 610 is attached to the electrode extraction part 606 by a method such as soldering dip method, and presoldering is performed in preparation for subsequent soldering to complete a coil component 3000.

### DESCRIPTION OF REFERENCE NUMERALS

100: resin substrate

102: groove

104: metallic coating

106: resist pattern

108: central conductive film

108a: portion formed in the groove, of the central conductive film

110: surface conductive film

112: coil element

200: component substrate

What is claimed is:

1. A method for manufacturing a coil element using a resin substrate by electroforming, comprising:
forming a groove on a substrate surface of the resin substrate in order to prevent overturning or dropping of the coil element;
forming a metallic coating serving as a seed layer to coat the resin substrate on which the groove is formed;
forming a resist pattern for forming a desired aspect ratio of the coil element, on the substrate surface to sandwich the groove, so as to have a desired thickness T, the resist pattern being a reverse pattern of the coil element pattern;
forming a central conductive film of the coil element on the substrate surface including the groove, by a first electroforming with the resist pattern as a mask, so as to have a height t equal to or less than the desired thickness T;
removing the resist pattern and the metallic coating exposed;
forming a surface conductive film by a second electroforming with the central conductive film as a foundation, to form the coil element made of the central conductive film and surface conductive film;
peeling away the coil element from the resin substrate; and
removing a portion formed in the groove, of the central conductive film of the peeled coil element by a reverse electrolytic etching.

2. The method according to claim 1, further comprising:
implanting the coil element peeled away from the resin substrate to a component substrate.
